(19) United States
(12) Patent Application Publication
(10) Pub. No.: US 2014/0209746 A1
(43) Pub. Date: Jul. 31, 2014

(54) WINDOW SHADING ASSEMBLY

(71) Applicant: THE BOEING COMPANY, Chicago, IL (US)

(72) Inventor: Brandon W. Dunn, Chicago, IL (US)

(73) Assignee: THE BOEING COMPANY, Chicago, IL (US)

(21) Appl. No.: 13/752,669

(22) Filed: Jan. 29, 2013

(51) Int. Cl. B64C 1/14; E06B 9/24

(52) U.S. Cl. CPC B64C 1/14; E06B 9/24
USPC 244/129.3; 160/237; 160/90; 160/98; 160/405

(57) ABSTRACT

A window shade assembly for a window includes a first member, a second member, a film, and an actuating device. The second member is disposed apart from the first member. The film has a first end coupled to the first member, a second opposed end coupled to the second member, an opaque portion, and a transparent portion. The actuating device is coupled to the first member or the second member for moving the first member or the second member to move the film between the first and the second members.

### FIELD OF THE DISCLOSURE

This disclosure relates to a window shading assembly which may be used in a wide variety of structures such as in an aircraft, in a vehicle, or in another type of structure to vary the amount of light coming through the window.

### BACKGROUND

It is often beneficial to be able to selectively alter the amount of light coming through a window in a structure such as in an aircraft or other type of structure. Aircraft typically utilize a plastic shade, contained in a housing, which slides over a window to allow a passenger to control the amount of light coming through the window. However, the housing occupies substantial volume behind the sidewall in the area over the window in order to contain the shade when it is in a lifted position. This housing prevents ducting, wiring, insulation, and other structures from being installed in that area. Moreover, the plastic shade is accessible to the passenger which may lead to the plastic shade becoming dirty, getting worn, or incurring damage. Additionally, this arrangement does not allow the user to gradually transition the amount of light coming through the window as the areas of the window covered by the plastic shade are completely opaque and the areas of the window not covered by the plastic shade are transparent.

Another type of existing shade includes one roller with a fabric sheet wrapped around the roller. The fabric sheet includes a free end that is configured to be hooked into a closed position. However, this arrangement does not allow the user to gradually transition the amount of light coming through the window, and further allows the user to have access to the fabric sheet which may lead to the fabric sheet becoming dirty, getting worn, or incurring damage. Still other existing window shade systems use electrically-dimmable glass or electrically-operated shutters to allow a user to control the control the amount of light coming through the window. However, these systems require their own power source and electric controls to adjust the opacity of the glass or to control movement of the electrically-operated shutters.

A window shade is needed to overcome one or more of the issues of one or more of the existing window shades.

### SUMMARY

In one embodiment, a window shade assembly includes a first member, a second member, a film, and an actuating device. The second member is disposed apart from the first member. The film has a first end coupled to the first member, a second opposed end coupled to the second member, an opaque portion, and a transparent portion. The actuating device is coupled to the first member or the second member for moving the first member or the second member to move the film between the first and the second members.

In another embodiment, a window shade assembly includes a window, a film, and an actuating device. The window has an inner pane and an outer pane. The film is disposed between the inner pane and the outer pane of the window, and has an opaque portion and a transparent portion. The actuating device is coupled to the film for moving the film between the inner pane and the outer pane of the window.

In still another embodiment, a method for operating a window shade assembly is disclosed. In one step, a film is moved so that a transparent portion of the film covers a section of a window in order to make the section of the window transparent to a viewer. In another step, the film is moved so that an opaque portion of the film covers the section of the window in order to make the section of the window opaque to the viewer.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a front perspective view of one embodiment of a window shade assembly attached to a structure comprising an aircraft;

FIG. 2 illustrates a front perspective view of the window shade assembly of FIG. 1 removed from the structure;

FIG. 3 illustrates a back view of the window shade assembly of FIG. 1 attached to the structure with a back window panel removed;

FIG. 4 illustrates a side view of the window assembly of FIG. 1 attached to the structure; and

FIG. 5 is a flowchart illustrating one embodiment of a method for operating a window shade assembly.

### DETAILED DESCRIPTION

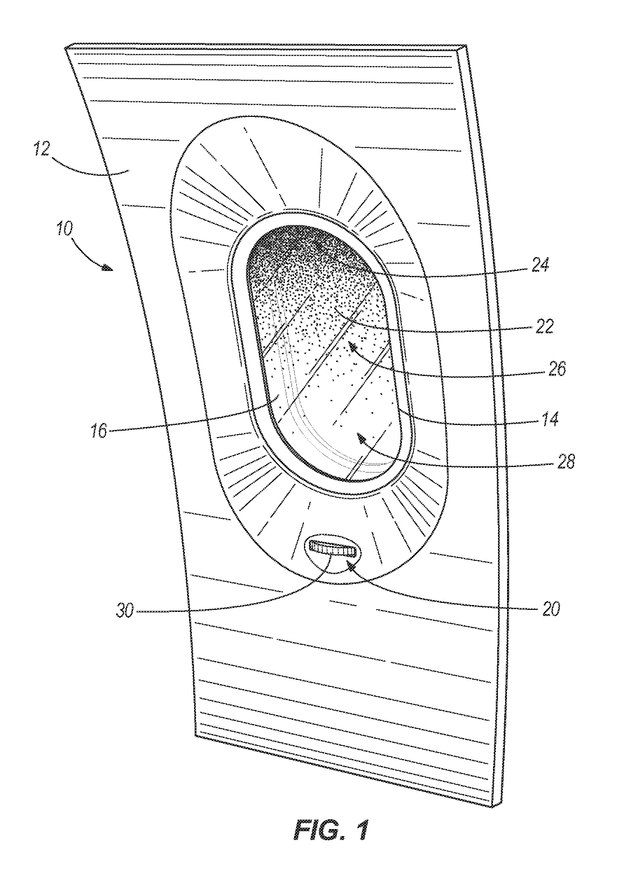

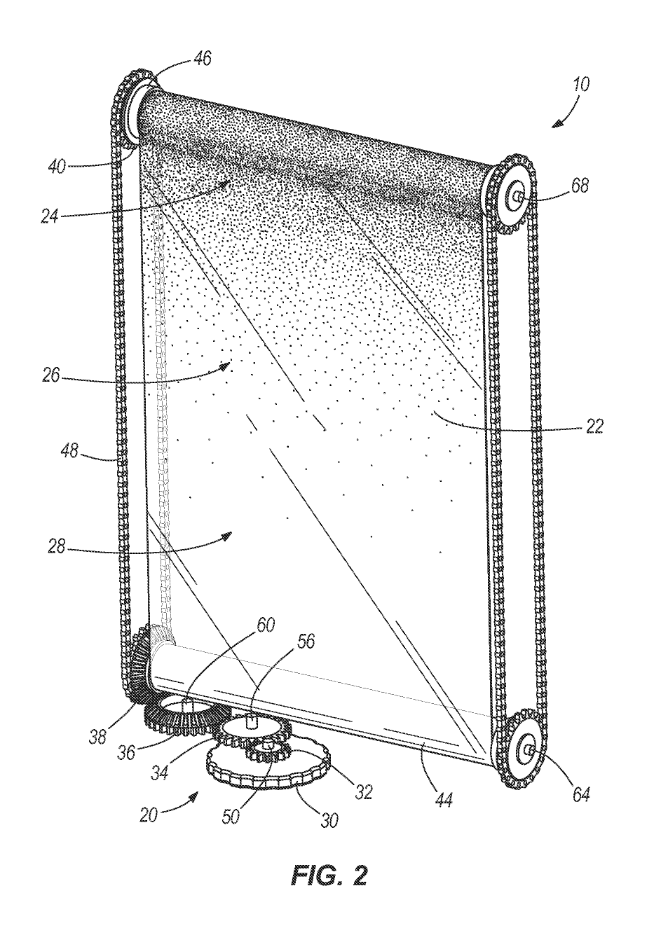

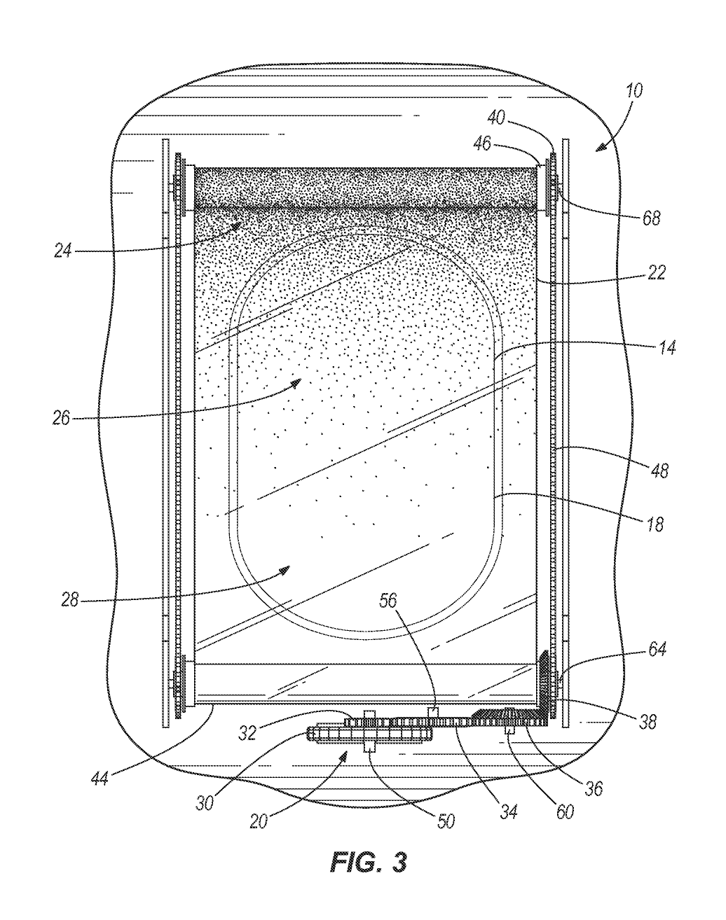

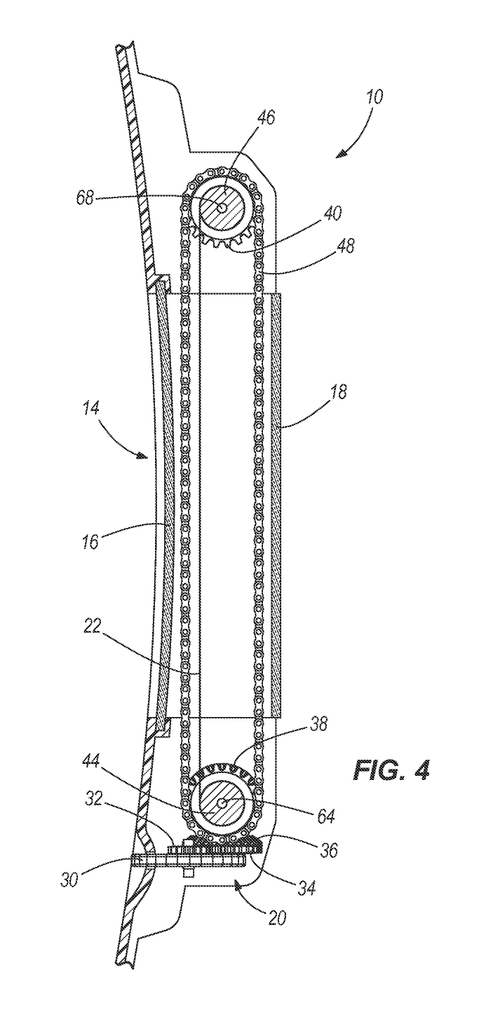

FIG. 1 illustrates a front perspective view of one embodiment of a window shade assembly 10 attached to a structure 12 comprising an aircraft. In other embodiments, the window shade assembly 10 may be attached to any type of structure such as any type of vehicle or varying structures. FIG. 2 illustrates a front perspective view of the window shade assembly 10 of FIG. 1 removed from the structure 12. FIG. 3 illustrates a back view of the window shade assembly 10 of FIG. 1 attached to the structure 12 with a back window panel removed. FIG. 4 illustrates a side view of the window assembly 10 of FIG. 1 attached to the structure 12.

As shown collectively in FIGS. 1-4, the window shade assembly 10 includes: a window 14; an inner pane 16; an outer pane 18; an actuating device 20; and a film 22. The inner pane 16 and the outer pane 18 of the window 14 are made of a transparent material such as glass or other transparent materials to allow a person to look through the window 14. The actuating device 20 and the film 22 are disposed between the inner pane 16 and the outer pane 18 of the window 14. The actuating device 20 is coupled to the film 22 for moving the film 22 within the window 14 between the inner pane 16 and the outer pane 18.

The film 22 is made of a material, such as transparent plastic film, which gradually transitions from an opaque portion 24, to a translucent portion 26, to a transparent portion 28. In other embodiments, the film 22 may be made of varying materials. The term ‘opaque’ is defined as being in a range of 80% to 100% opacity. The term ‘translucent’ is defined as being in a range of 30% to 80% opacity. The translucent portion 26 is gradiated such that its opacity varies from a higher percentage adjacent the opaque portion 24 to a lower percentage adjacent the transparent portion 28. In other embodiments, the gradiation of the translucent portion 26 may vary. The term ‘transparent’ is defined as being in a range of 0% to 30% opacity. In other embodiments, the ranges may vary. In still other embodiments, the arrangement, configuration, and respective sizes of the opaque portion 24, the translucent portion 26, and the transparent portion 28 may vary, or one or more of the opaque portion 24, the translucent portion 26, or the transparent portion 28 may not be present. The film 22 has an ultra-violet resistance in a range of 100 kLy/yr to 1,000 kLy/yr, and a heat resistance in a range of −40 C to 100 C. The film 22 is flexible enough to bend in a radius of 0.25″ to 0.5″ with no plastic deformation. In other embodiments, the ranges may vary.

The actuating device 20 is used to move the film 22 to control whether the opaque portion 24, the translucent portion 26, or the transparent portion 28, or a combination thereof, covers the window 14. The opaque portion 24, the translucent portion 26, and the transparent portion 28 of the film 22 are each separately sized to completely cover the window 14 when they are each separately aligned over the window 14. In such manner, when the opaque portion 24 is disposed to completely cover the window 14 the window 14 is opaque. Similarly, when the translucent portion 26 is disposed to completely cover the window 14 the window 14 is translucent. Finally, when the transparent portion 28 is disposed to completely cover the window 14 the window 14 is transparent. In other embodiments, the size and configurations of the opaque portion 24, the translucent portion 26, and the transparent portion 28 of the film 22 may vary. For instance, in one embodiment the opaque portion 24, the translucent portion 26, and the transparent portion 28 may gradually transition into each other via a gradient so that a top of the window 14 may be opaque which fades into a translucent bottom half of the window 14. For instance, the translucent portion 26 may be gradiated such that its opacity varies from a higher percentage adjacent the opaque portion 24 to a lower percentage adjacent the transparent portion 28. In still other embodiments, varying configurations may be utilized.

The actuating device 20 includes: a control member 30; gears 32, 34, 36, 38, and 40; a first member 44; a second member 46; and a third member 48. The control member 30 is used by a person to control movement of the actuating device 20 to mechanically move the film 22 relative to the window 14 without the necessity of a power source. The control member 30 is a knob which a passenger may rotate to cause the knob to rotate around or with a first shaft 50. In other embodiments, the control member 30 may be a lever or other type of control member.

The first gear 32 is concentrically connected to the first shaft 50 so that when the control member 30 is rotated, the first shaft 50 is rotated causing the first gear 32 to rotate. The first gear 32 is aligned in parallel arrangement against the second gear 34 to rotate the second gear 34 around or with a second shaft 56. The second gear 34 is aligned in parallel arrangement against the third gear 36 to rotate the third gear 36 around or with a third shaft 60. The third gear 36 is aligned in perpendicular arrangement against a fourth gear 38 to rotate the fourth gear 38. The fourth gear 38 is connected to the first member 44 so that when the fourth gear 38 rotates around or with a fourth shaft 64 the first member 44 also rotates around or with the fourth shaft 64. The first member 44 is a roller which is disposed at a bottom of the window 14. In other embodiments, the first member 44 may vary. In still another embodiment, the first member 44 may act as the fourth shaft 64 if the fourth gear 38 is formed with or coupled to the first member 44. In other embodiments, varying configurations may be utilized.

The third member 48 is coupled between and to the fourth gear 38, which is connected to the first member 44, and the fifth gear 40 connected to the second member 46. The third member 48 is a chain, belt, or other type of member. When the fourth gear 38 rotates around or with the fourth shaft 64, thereby rotating the attached first member 44 around or with the fourth shaft 64, the coupled third member 48 also rotates thereby rotating the fifth gear 40 and the attached second member 46 around or with a fifth shaft 68. The second member 46 is a roller which is disposed at a top of the window 14 apart from the first member 44. In other embodiments, the second member 46 may vary. In still another embodiment, the second member 46 may act as the fifth shaft 68 if the fifth gear 40 is formed with or coupled to the second member 46. In other embodiments, varying configurations may be utilized.

The film 22 is continuously disposed against, around, and in-between the first member 44 and the second member 46 so that when the first member 44 rotates around or with the fourth shaft 64 and the second member 46 rotates around or with the fifth shaft 68, the film 22 moves around or with the first and second members 44 and 46. As a result, due to the above described arrangement, when a person rotates the control member 30 the person is able to selectively control whether the opaque portion 24, the translucent portion 26, or the transparent portion 28 of the film 22, or a combination thereof, is disposed over the window 14 to selectively control whether the window is opaque, translucent, transparent, or a combination thereof. In other embodiments, a varying number, type, configuration, alignment, or material may be used for any of the components of the window shade assembly 10.

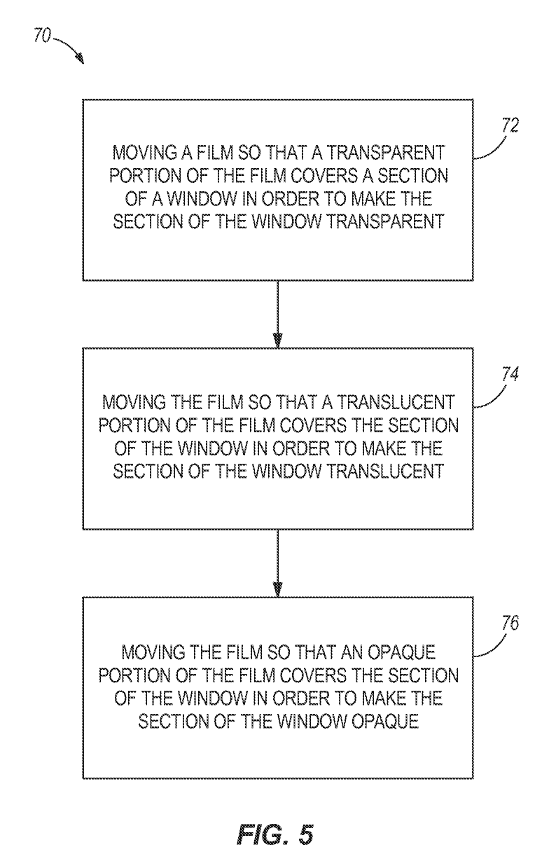

FIG. 5 is a flowchart illustrating one embodiment of a method 70 for operating a window shade assembly. In step 72, a film is moved so that a transparent portion of the film covers a section of a window in order to make the section of the window transparent. During this step, an opaque portion of the film and a translucent portion of the film may be rolled around a second member towards the first member and the transparent portion of the film may be rolled around the first member towards the second member to be disposed between the first and the second members. In step 74, the film is moved so that a translucent portion of the film covers the section of the window in order to make the section of the window translucent. During this step, the opaque portion of the film may be further rolled towards the first member, the transparent portion of the film may be rolled around the second member, and the translucent portion of the film may be rolled from the first member towards the second member to be disposed between the first and the second members. In step 76, the film is moved so that an opaque portion of the film covers the section of the window in order to make the section of the window opaque. During this step, the transparent portion of the film and the translucent portion of the film may be rolled around the second member and the opaque portion of the film may be rolled around the first member towards the second member to be disposed between the first and the second members. In one embodiment, each of steps 72, 74, and 76 may further include moving the film between panes of the window due to a user moving a control member to mechanically move the film using a mechanical actuating device without a power source. The window shade assembly and the window may be a portion of an aircraft, vehicle, or other type of structure. In other embodiments, one or more steps may be modified in substance or in order, or one or more steps may be added depending on the configuration of the film which may vary.

One or more embodiments of the disclosure may reduce one or more issues of one or more of the existing window shades by: reducing the size needed for the window shade; allowing a user to mechanically control the window shade without a power source; allowing a user to selectively transition the shading of the window between opaque, translucent, and transparent; disposing the window shade away from the user thereby preventing the window shade from become dirty, worn, or damaged; or by containing one or more additional advantages.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the disclosure is defined by the appended claims. Accordingly, the disclosure is not to be restricted except in light of the appended claims and their equivalents.

1. A window shade assembly comprising:
a first member;
a second member disposed apart from the first member;
a film having a first end coupled to the first member and a second opposed end coupled to the second member, the film having an opaque portion and a transparent portion; and
an actuating device coupled to the first member or the second member for moving the first member or the second member to move the film between the first and the second members.

2. The window shade assembly of claim 1 wherein the first member and the second member each comprise a roller.

3. The window shade assembly of claim 1 wherein the film transitions from the opaque portion to a translucent portion to the transparent portion with the translucent portion being gradiated such that its opacity varies from a higher percentage adjacent the opaque portion to a lower percentage adjacent the transparent portion.

4. The window shade assembly of claim 1 wherein the actuating device comprises a control member coupled to a chain or belt that is coupled to the first member or the second member.

5. The window shade assembly of claim 4 wherein the control member comprises a knob or lever coupled to a plurality of gears coupled to the chain or belt.

6. The window shade assembly of claim 1 wherein the film continuously wraps around the first member and the second member.

7. The window shade assembly of claim 1 wherein the opaque portion and the transparent portion are each sized to completely cover a viewable section of the window.

8. A window shade assembly comprising:
a window having an inner pane and an outer pane;
a film disposed between the inner pane and the outer pane of the window, the film having an opaque portion and a transparent portion; and
an actuating device coupled to the film for moving the film between the inner pane and the outer pane of the window.

9. The window shade assembly of claim 8 wherein the window shade assembly is disposed between an inner wall and an outer wall of an aircraft.

10. The window shade assembly of claim 8 wherein the inner pane and the outer pane are each made of a transparent material.

11. The window shade assembly of claim 8 further comprising a first member disposed at a bottom of the window and a second member disposed at a top of the window, wherein the film is disposed against and in-between the first member and the second member, and the first member or the second member is configured to move the film between the inner and outer panes of the window.

12. The window shade assembly of claim 11 wherein the first member and the second member each comprise a roller.

13. The window shade assembly of claim 12 wherein the actuating device comprises a control member coupled to a chain or belt that is coupled to the first member or the second member.

14. The window shade assembly of claim 13 wherein the control member comprises a knob or lever, and the actuating device further comprises a plurality of gears coupling the knob or lever to the chain or belt.

15. The window shade assembly of claim 8 wherein the film transitions from the opaque portion to a translucent portion to the transparent portion with the translucent portion being gradiated such that its opacity varies from a higher percentage adjacent the opaque portion to a lower percentage adjacent the transparent portion.

16. A method for operating a window shade assembly comprising:
moving a film so that a transparent portion of the film covers a section of a window in order to make the section of the window transparent to a viewer; and
moving the film so that an opaque portion of the film covers the section of the window in order to make the section of the window opaque to the viewer.

17. The method of claim 16 wherein the moving the film steps each further comprise moving the film through a passage defined between panes of a window.

18. The method of claim 16 wherein the moving the film steps each further comprise manually moving a control member to mechanically move the film using a mechanical actuating device.

19. The method of claim 16 further comprising moving the film so that a translucent portion of the film covers the section of the window in order to make the section of the window translucent to the viewer.

20. The method of claim 16 wherein moving the film further comprises selectively moving the film between a pair of spaced apart rollers.
